(19) United States
(12) Patent Application Publication
(10) Pub. No.: US 2008/0081611 A1
(43) Pub. Date: Apr. 3, 2008

(54) Method and apparatus for sharing cellular account subscription among multiple devices

(75) Inventors: Riley Steven Hoyt, Fort Langley (CA); Steven Lawrence Gielty, Coquitlam (CA); William Yih Yuan Waung, Burnaby (CA)

Correspondence Address: THELEN REID BROWN RAYSMAN & STEINER LLP, P. O. BOX 640640, SAN JOSE, CA, 95164-0640, US

(73) Assignee: Sierra Wireless, Inc., Richmond (CA)

(21) Appl. No.: 11/543,419

(22) Filed: Oct. 3, 2006

(51) Int. Cl. H04Q 7/20

(52) U.S. Cl. 455/425

(57) ABSTRACT

A method and a system for sharing a subscriber identity module (“SIM”) card by multiple devices are disclosed. In one embodiment, the system includes a SIM card, a handset device, a digital processing device, and a wireless modem. A handset device coupled, in one embodiment, is a cellular phone and is coupled to the SIM card. The handset device further includes short-range wireless circuitry that is capable of providing short range wireless communication with other short-range wireless devices. In one embodiment, the digital processing device is capable of obtaining the SIM data from the SIM card via a PAN, and then uses received SIM data to access the wireless communications network.

### FIELD OF THE INVENTION

The present invention relates to communications network. More specifically, the present invention relates to wireless communications.

### BACKGROUND OF THE INVENTION

With increasing popularity of using the wireless communication to access Internet and/or World Wide Web (“Web”), wireless communications devices are ubiquitous in today's culture. Conventional wireless communications devices such as cellular phones, one-way/two-way pagers, laptop computers and personal digital assistants (“PDA”) typically allow users to maintain constant contact with their work. The cellular phones can typically handle voice and short message communications. One-way/two-way pagers typically provide short data messages and laptop computers with wireless capabilities can typically handle high speed data manipulations. These devices are typically capable of transmitting and/or receiving audio, image, and/or data wirelessly. For example, cellular phones can transmit and receive audio and text messaging. In addition to data processing, PDAs or laptop computers can also transmit and/or receive electronic mail (“email”) over the Internet or the Web.

In order to achieve this diverse set of mobile data capabilities, users typically require to carry multiple devices to satisfy their needs. For example, a user may carry a cellular phone for voice or audio communications and may also bring a wireless capable laptop computer for data communications. Some users may further use two-way pagers such as a Blackberry™ for email access. Some users even employ IP phones or Smartphones, which combine the functionality of voice and data for voice and data communications.

Each wireless communications device typically requires a subscriber identity module (“SIM”) in order for the device to access a wireless communications network. Having multiple wireless communications devices typically require the user to have multiple SIM card accounts or cellular (wireless) accounts with the wireless communications network providers, i.e. T-mobile or Verizon because each wireless device typically requires one SIM card account to operate. For example, a cellular phone requires a SIM card to access a wireless communications network for transmitting/receiving voice information. Also, a laptop computer with a wireless capability requires another SIM card to access a wireless communications network for transmitting/receiving data. Similarly, a two-way pager may further require a third SIM card to access a wireless communications network for transmitting/receiving emails. If every user demands multiple SIM card accounts, a large number of SIM card accounts will be needed to satisfy all users' demand. To maintain a large amount of SIM card accounts not only increases the complexity of maintaining these accounts, but also degrades overall performance of the wireless communications network.

In order to reduce the number of SIM cards, there is a need in the art to have a method of sharing a single cellular account among multiple wireless devices for communicating voice, data and/or graphical information over a wireless communications network.

### SUMMARY OF THE INVENTION

The present invention discloses a technique of sharing a subscriber identity module (“SIM”) card with multiple devices. In one embodiment, the system includes a SIM card, a handset device, a digital processing device, and a wireless modem. The SIM card includes subscription information, also known as SIM data. A handset device, which may be a cellular phone, is coupled to the SIM card. The handset device also employs short-range wireless circuitry for short-range wireless communications such as personal area networks (“PANs”). PANs, for example, may use the technology of infrared transmission, or radio frequency (“RF”) based communications such as Bluetooth technology. The digital processing device uses its on-board short-range wireless circuitry to communicate with the handset device via a PAN. In one embodiment, the digital processing device is capable of obtaining the SIM data from the SIM card via a PAN, and then uses received SIM data to access the wireless communications network.

Additional features and benefits of the present invention will become apparent from the detailed description, figures and claims set forth below.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a wireless communication system in accordance with one embodiment of the present invention;

FIG. 2 is an alternative configuration illustrating multiple laptops sharing a SIM card in accordance with one embodiment of the present invention;

FIG. 3 illustrates a digital processing device in accordance with one embodiment of the present invention; and

FIG. 4 is a flowchart illustrating a process of obtaining SIM data from a remote device in accordance with another embodiment of the present invention.

### DETAILED DESCRIPTION

A method and device for sharing a SIM card among multiple devices are disclosed.

Those of ordinary skill in the art will realize that the following detailed description of the present invention is illustrative only and is not intended to be in any way limiting. Other embodiments of the present invention will readily suggest themselves to such skilled persons having the benefit of this disclosure. It will be apparent to one skilled in the art that these specific details may not be required to practice to present invention. In other instances, well-known circuits and devices are shown in block diagram form to avoid obscuring the present invention. In the following description of the embodiments, substantially the same parts are denoted by the same reference numerals.

In the interest of clarity, not all of the features of the implementations described herein are shown and described. It will, of course, be appreciated that in the development of any such actual implementation, numerous implementation-specific devices must be made in order to achieve the developer's specific goals, wherein these specific goals will vary from one implementation to another and from one developer to another. Moreover, it will be appreciated that Such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

While particular embodiments of the present invention have been shown and described, it will now be apparent to those skilled in the art having the benefit of this disclosure that many more modifications than mentioned above are possible without departing from the inventive concepts disclosed herein. Therefore, the appended claims are intended to encompass within their scope all such modifications as are within the spirit and scope of this invention.

The present invention discloses a technique of sharing a subscriber identity data repository (“SIDR”) with multiple devices. An example of SIDR is a subscriber identity module (“SIM”) card. In one embodiment, the system includes a SIM card, a handset device, a digital processing device, and a wireless modem. The SIM card includes subscription information, also known as SIM data. A handset device, which may be a cellular phone, is coupled to the SIM card. The handset device also employs short-range wireless circuitry for short-range wireless communications such as personal area networks (“PANs”). PANs, for example, may use the technology of infrared transmission, or radio frequency (“RF”) based communications such as Bluetooth technology. The digital processing device uses its on-board short-range wireless circuitry to communicate with the handset device via a PAN. In another embodiment, a secured cable connection is used between the handset device and the digital processing device for short-range communications. In one embodiment, the digital processing device is capable of obtaining the SIM data from the SIM card via a PAN, and then uses received SIM data to access the wireless communications network. The wireless communications network provides long-range wireless communications and it is supported by wireless communications network providers such Verizon and T-mobile.

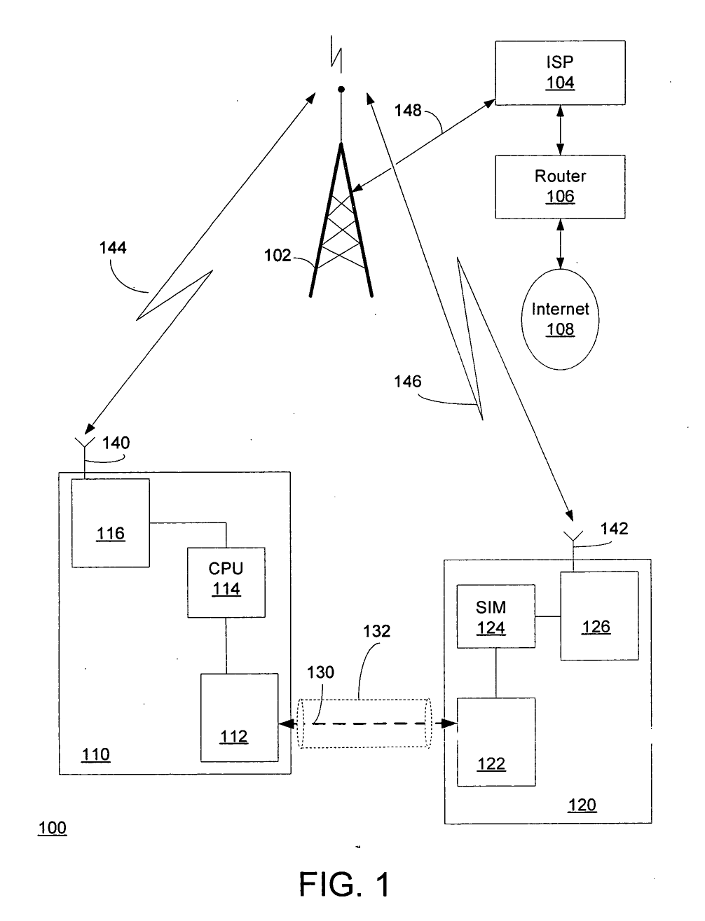

FIG. 1 is a block diagram illustrating a wireless communication system 100 in accordance with one embodiment of the present invention. System 100 includes a handset device 120, a digital processing device 110, and a base station 102. Handset device 120 includes a SIM card 124, a short-range wireless component 122, and a long-range wireless component 126. In one embodiment, handset device 120 is a cellular phone. Short-range wireless component 122 having short-range wireless circuitry is capable of communicating with other short-range wireless components or devices via PANs. For example, short-range wireless component 122 is capable of communicating with digital processing device 110 via a short-range wireless communications network or a PAN 130. Long-range wireless component 126 is configured to transmit/receive data through its antenna 142 to/from a wireless communications network via a wireless media 146. Long-range wireless component 126, in one embodiment, is a phone modem. It should be noted that handset device 120 could be a laptop computer or a desktop computer. It should be further noted that a SIM card 124 could be any type of SIDR that stores subscriber identity data.

Handset device 120 and digital processing device 110, in another embodiment, include cable communication circuits for short-range communications using cable connections. Instead of using short-range wireless communications as discussed earlier, a cable is used to connect between handset device 120 and digital processing device 110 for data transfer. The cable can be one of several conventional cables, such as a Universal Serial Bus (“USB”) cable, an optical cable, or a FireWire (IEEE 1394) cable. To establish data transfer over a cable connection, a secure channel 132, in one embodiment, should be established before the cable is used for transmitting the SIM data.

SIM card 124 stores data or the SIM data wherein the SIM data includes subscriber related information such as subscriber configuration, customization information, requirements and/or preferences. The subscriber configuration information may also identify a home service area, a list of frequently called numbers, voice recognition samples, a list of most recent calls received and/or placed by the subscriber, a notification setting (e.g., ring or vibrate), a list of short messages, etc. To facilitate wireless communications, a cellular phone obtains the SIM data from a SIM card, which may be inserted into a SIM socket in the cellular phone and uses the SIM data to access a wireless communications network, such as a Verizon or a Cingular wireless network. The SIM data may further include information about the identity of subscriber, telephone number, location area identity, and authenticate of the mobile subscriber and it can be accessed by a remote device for accessing the wireless communications network. In one embodiment, the SIM card is a Universal Subscriber Identity Module (“USIM”).

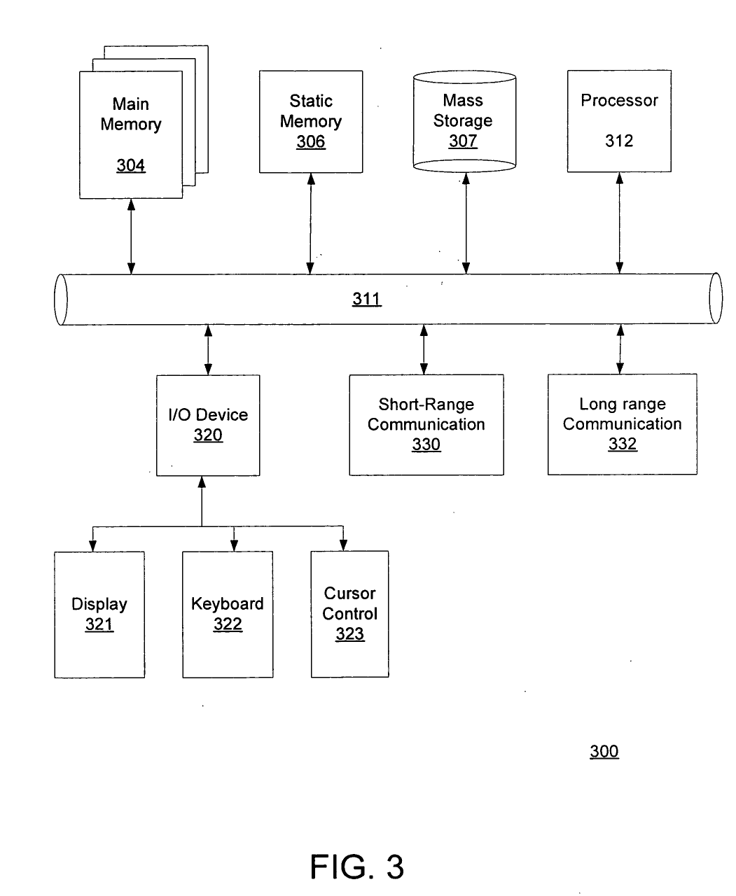

Digital processing device 110 includes a modem 116, a CPU 114, and a short-range wireless component 112. In one embodiment, digital processing device 110 is a laptop computer with wireless capabilities. Modem 116 is capable of communicating with various wireless communications networks via wireless media 144. CPU 114, which will be described more detail in FIG. 3, is a general purpose microprocessor that is capable of executing instructions. CPU 114, in one embodiment, controls modem 116 and short-range wireless component 112. Short-range wireless component 112 having short-range wireless circuitry is capable of talking or communicating with another short-range wireless device such as short-range wireless component 122 via a PAN. To set up a short range wireless channel or a PAN 130 between component 112 and component 122, a secure channel 132 may need to be established prior to PAN 130.

Base station 102 transmits and/or receives voice modulated signals and digital data to or from a mobile switching center, not shown in the figure. Switching center communicates with a remote device (e.g. a telephone and/or a gateway device) over the PSTN (Public Switched Telephone Network). Base station 102 is also coupled to an Internet Service Provider server 104 (“ISP server”) for transmitting/receiving data modulated signals. ISP server 104 transmits/receives data to/from a gateway or router 106, which further sends/receives the data to/from a remote device over the Internet 108.

System 100 allows the handset device 120 to share its SIM card 124 with wireless device. For example, digital processing device 110 obtains the SIM data from SIM card 124 to access a wireless communications network. A mobile user usually carries a cellular telephone 120 which contains a SIM card 124 and cellular telephone 120 is most likely to be within close proximity to the user. When cellular telephone 120 is being located or identified within a vicinity of a computer 110 used by the user, system 100 allows the digital processing device 110 to obtain the SIM data from SIM card 124 to access a wireless communications network via a wireless media 144. In one embodiment, system 100 facilitates a process of sharing a SIM card including the steps of initializing devices, identifying nearby devices, establishing a PAN, and connecting to a wireless communications network.

For the initialization stage, a series of commands is executed on both cellular phone (handset device) 120 as well as a laptop computer (digital processing device) 110 so that cellular phone 120 and laptop computer 110 will recognize with each other during the process of authentication for establishing a PAN. In one embodiment, the commands for the initialization only need to be executed once for both cellular phone 120 and laptop computer 110. In another embodiment, the commands for the initialization need to be executed prior to every identification stage.

Referring back to FIG. 1, to initiate a wireless connection 144, a high-speed data modem 116 in digital processing device or laptop computer 110 needs to obtain necessary SIM information from a nearby phone 120 through a short-range wireless communications network or a PAN 130. Laptop computer 110 starts by searching or identifying for a compatible cellular telephone 120. Once a compatible cellular phone 120 is identified, laptop computer 110 may request to establish a PAN. To establish a PAN or a short-range wireless communications network 130, a secure channel 132 may need to be established first. For example, when a request for SIM information, cellular telephone 120 may initiate a secure communications channel (e.g. through encryption) 132 before the establishment of a PAN 130 to prevent any unauthorized accesses to the SIM data. Using secure channel 132, the devices verify each other's identity through a validation mechanism, which may include the exchange of secret authentication keys. These keys may be established during the initiation process as discussed earlier. After both laptop computer 110 and cellular telephone 120 are verified and/or authenticated, laptop computer 110 can use encrypted and secure channel 132 to transfer the SIM data. In one approach, cellular telephone 120 may make the Application Programming Interface (API) to the SIM data available to an authenticated laptop computer 110.

After a secured channel 132 and/or a PAN 130 is established between laptop computer 110 and cellular phone 120, laptop computer 110 can request a wireless connection 144 to a wireless communications network via its modem 116. All requests for validation and verification of SIM data received from the network are then processed into appropriate data query commands that are sent to cellular telephone 120 through secure channel 132. Cellular telephone 120 executes the requests received from laptop computer 110 and sends responses back to laptop computer 110. Laptop computer 110 then uses the answers received from cellular telephone 120 to respond to the queries from the wireless providers for accessing the wireless communications network. Once the requests are validated, laptop computer 110 is successfully logged onto the wireless or cellular network.

In one embodiment, communications between digital processing device 110 and cellular telephone 120 may be accomplished through encapsulation of commands specified in 3GPP of the Subscriber Identity Module—Mobile Equipment (SIM-ME) interface. For example, laptop computer 110 may use handset device 120 to perform the necessary authentication and cipher key generation procedure. When laptop computer 110 receives a Random Number (RAND) from the cellular network, it passes the RAND to handset device 120 through the secure communications channel 132 in the encapsulated command RUN GSM ALGORITHM. Handset device 120 then passes the RAND received from laptop computer 110 to SIM card 124 in the command RUN GSM ALGORITHM. SIM card 124 returns the values SRES and Kc to handset device 120, which in turn sends these values to laptop computer 110 through the secure communications channel 132. Laptop computer 110 then sends the SRES to the wireless or cellular network. The network compares this value with the value of SRES which it calculates for itself. The comparison of these SRES values provides the authentication. The value Kc is used by laptop computer 110 in any future enciphered communications with the network until the next invocation of this mechanism.

In one embodiment, the access of the SIM information may be limited only to a specific subset of the data on the SIM card. In addition, digital processing device 110 may need to satisfy the requirements identified in 3GPP TS 11.10-4 Mobile Station (MS) Conformance Specification.

It should be noted that the underlying concept of the present invention would not change if handset device 120 is replaced with any other types of digital processing device. Moreover, it is apparent to one of ordinary skilled in the art that SIM card 124 can be replaced with a SIDR.

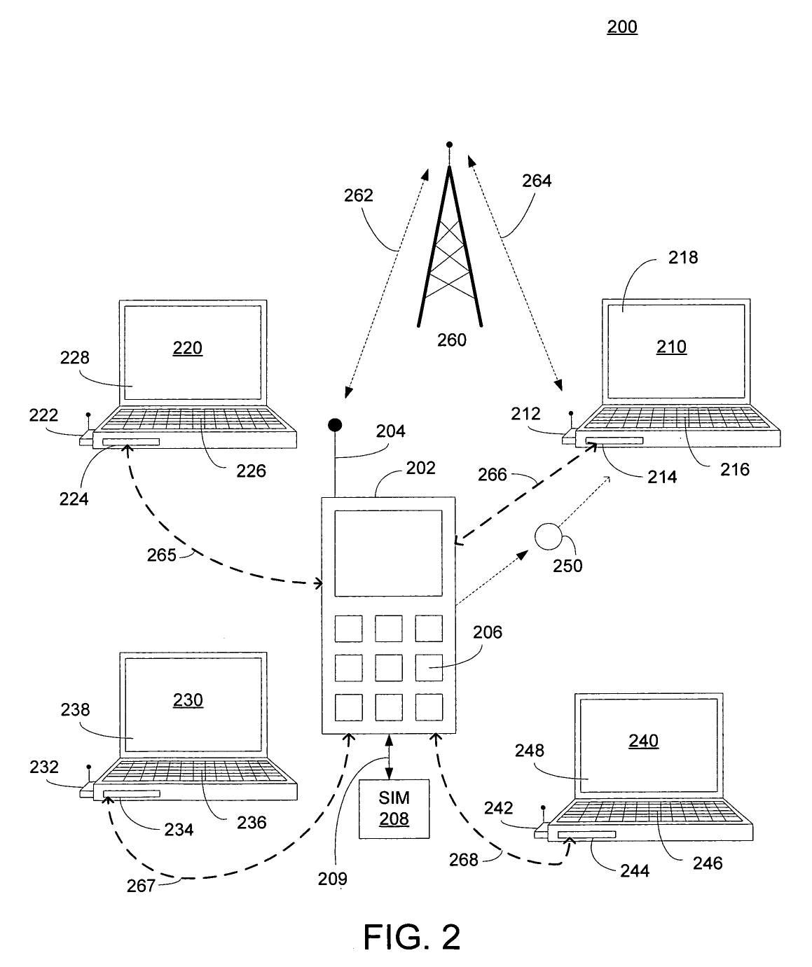

FIG. 2 is an alternative configuration of a wireless system 200 illustrating laptop computers accessing a nearby SIM card 208 onboard a cellular phone 202 in accordance with one embodiment of the present invention. System 200 includes four laptop computers 210-240, a cellular phone 202, and a base station 260. Cellular phone 202 includes an antenna 204, SIM card 208, and keypad 206. Antenna 204 is capable of transmitting or receiving information to/from base station 260 via wireless channel or media 262. SIM card 208 is inserted into cellular phone 202 via a connector 209. In order to access the SIM data from SIM card 208, the laptop computer needs first to obtain a permission 250 for accessing cellular phone 202 because, in one embodiment, cellular phone 202 allows one device that can access the SIM data at any given time.

Referring back to FIG. 2, laptop computers 210-240 contain similar components such as displays 218, 228, 238, 248, short-range wireless circuitries 214, 224, 234, 244, modems 212, 222, 232, 242, and keyboards 216, 226, 236, 246. Laptop computers 210-240 are capable of setting up PANs 265, 266, 267, or 268 with cellular phone 202. For example, upon receiving token 250 and establishing a secure channel 266 with cellular phone 202, laptop computer 210 can communicate with the wireless communications network via wireless media 264 after it obtains the SIM data.

Referring back to FIG. 2, system 200 illustrates that it is possible that multiple devices (more than one laptop computers) simultaneously request of accessing the same SIM information. It should be noted that care should be taken to limit multiple concurrent authentication processes. For example, if two devices were allowed to interleave authentication request/responses using a single set of SIM information, irrecoverable overwriting of the SIM data and/or authentication conflicts may occur. In one embodiment, cellular phone handset 202 (or other devices having a SIM card storing the SIM data) implements a lock-out mechanism to ensure that device authentication processes are serialized. For example, once handset 202 receives the RUN GSM ALGORITHM command with the RAND, it sets a flag to disallow servicing of another RUN GSM ALGORITHM command until successful authentication has been indicated, or a preset time-out period has expired. While the above is an example of how prevention of concurrent authentication can be avoided, other mechanisms can be implemented to provide the equivalent effect. It should be noted that the above example uses GSM/GPRS/UMTS SIM technology, similar functionalities are application to CDMA RUIM technologies.

It should be noted that some wireless communications networks only allow a single device to be registered on the network for each set of SIM information. Various control mechanisms may be used to ensure the compliance of such requirement. As mentioned earlier, cellular handset device 202 can implement a token passing mechanism so that if a laptop computer is successfully registered with the network, the laptop computer would be deemed to hold the “registration token”, and the handset's radio or modem is disabled to prevent it from registering with the network. Furthermore, handset 202 would reject SIM data requests from other trusted devices. In order to avoid loss of the token, a periodic token keep-alive message exchange may be implemented. Additional token passing messages may be implemented to allow the laptop computer to return the token to cellular handset 202 when it is no longer needed.

An advantage of using the present invention is to allow more than one wireless devices to share a single set of SIM data for accessing the cellular services. Each mobile user only needs to set up a single SIM card account with the cellular carrier for multiple wireless devices (or services). With reduced number of SIM card accounts, the present invention improves the wireless network traffic and consequently, enhances the network performance.

FIG. 3 illustrates a digital processing device 300 in accordance with one embodiment of the present invention. Computer system 300 includes an input/output (“IO”) unit 320, a processor 312, a main memory 304, a system bus 311, a static memory device 306, a mass storage memory 307, a short-range communication 330 and a long range communication 332 (or modem). Bus 311 is used to transmit information between various components and processor 312 for data processing. Processor 312 may be any of a wide variety of general-purpose processors or microprocessors such as Pentium™ microprocessor, or Power PC™ microprocessor. It should be noted that system 300 could be incorporated into digital processing device 110 and/or handset device 120.

Main memory 304, which may include multiple levels of cache memories, stores frequently used data and instructions. Main memory 304 may be RAM (random access memory), MRAM (magnetic RAM), or flash memory. Static memory 306 may be a ROM (read-only memory), which is coupled to bus 311, for storing static information and/or instructions. Mass storage memory 307, which may be a magnetic disk, an optical disk, hard disk drive, floppy disk, CD-ROM, and/or flash memories for storing large amounts of data. I/O unit 320, in one embodiment, includes a display 321, keyboard 322, and cursor control device 323. Display device 321 may be a liquid crystal device, cathode ray tube (“CRT”), touch-screen display, or other suitable display device. Keyboard 322 may be a conventional alphanumeric input device for communicating information between computer system and computer operator(s). Another type of user input device is cursor control device 323, such as a conventional mouse, touch mouse, trackball, or other type of cursor for communicating information between system and user(s).

Long range communication device 332 is coupled to bus 311 for accessing information from remote computers or servers through a wide-area network. Long range communication device 332 may include a modem or a network interface device, or other similar devices that facilitate communication between computer 200 and a network. Short-range communication device 330 is coupled to bus 311 for facilitating and establishing a PAN with other short-range wireless devices.

The present invention includes various processing steps, which will be described below. The steps of the present invention may be embodied in machine or computer executable instructions. The instructions can be used to cause a general purpose or special purpose system, which is programmed with the instructions to perform the steps of the present invention. Alternatively, the steps of the present invention may be performed by specific hardware components that contain hard-wired logic for performing the steps, or by any combination of programmed computer components and custom hardware components. While embodiments of the present invention will be described with reference to wireless communications network, the method and apparatus described herein is equally applicable to other network infrastructures or other data communications environments.

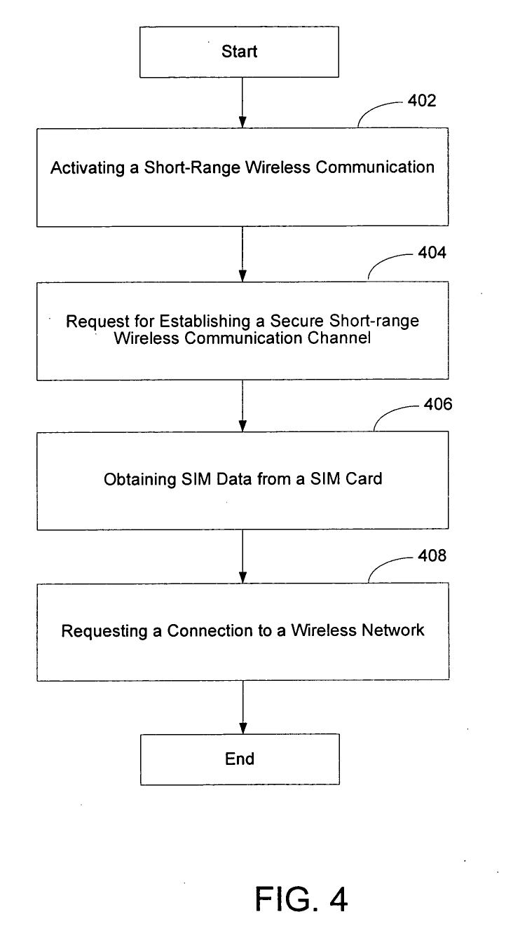

FIG. 4 is a flowchart illustrating a process of obtaining SIM data from a remote device in accordance with one embodiment of the present invention. At block 402, the process activates a short-range wireless communication to identify a handset device with a SIM card. In one embodiment, the process first initializes the handset device to include information for identifying the digital processing device and also initializes the digital processing device to include information for identifying the handset device. In one embodiment, the handset device is a cellular phone. Once the handset device with a SIM card is identified, the process proceeds to the next block.

At block 404, the process issues a request for establishing a secure short-range wireless communication channel between the handset device and a digital processing device. To establish a secure short-range wireless communication, the process further includes the steps of transmitting a first secret authentication key from the digital processing device to the cellular phone, and then, passing a second secret authentication key from the cellular phone to the digital processing device. Once the first secret authentication key and the second secret authentication key are verified and confirmed, a secured short-range wireless communication channel is established. In one embodiment, the secured short-range wireless communication network is a PAN. PAN includes, but not limited to, Bluetooth, Ultra Wideband, ZigBee, or Ambient networks. After the secured short-range wireless communication network is established, the process moves to block 406.

At block 406, the process obtains SIM data from the SIM card via the secure short-range wireless communication channel. In one aspect, the SIM data includes identifying mobile subscriber, telephone number, and location area identity. In one embodiment, the process encrypts the SIM data before it is being transmitted through the secure short-range wireless communication channel. After block 406, the process proceeds to the next block.

At block 408, the process requests a connection to a wireless communications network in accordance with the SIM data. In one aspect, the process instructs a wireless modem residing on a removable PCI-Express MiniCard that is logically coupled to the digital processing device to issue a request for connecting to the wireless communications network. In one embodiment, the process first allows the digital processing device to obtain a token, which permits the digital processing device to access the SIM card. The token, in this embodiment, is used to ensure that only one device can request for wireless communications network at any given time with one set of SIM data. During the operation, the process transmits the authentication request to the SIM card through the secure short-range wireless communication channel and then, receives an authentication response for the authentication request from the SIM card via the secure short-range wireless communication channel. Upon receipt of the authentication response, the process transmits the authentication response to the wireless communications network. When a connection to the wireless communications network is established, the process ends.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope all such changes and modifications as are within the true spirit and scope of this invention.

What is claimed is:

1. A system for communication, comprising:
a subscriber identity data repository (“SIDR”) including subscription information;
a device coupled to the SIDR and configured to have a first short-range communication circuit capable of providing short-range communications;
a digital processing device having a second short-range communication circuit capable of communicating with the first short-range communication circuit, wherein the digital processing device is configured to obtain the subscription information stored in the SIDR via the short-range communications; and
a wireless modem coupled to the digital processing device and configured to communicate with a wireless communications network in response to the subscription information received from the device.

2. The system of claim 1, wherein the device is a handset device.

3. The system of claim 1, wherein the SIDR is a SIM card.

4. The system of claim 1, further comprising a scheduling program residing in the digital processing device for controlling access to the wireless communications network.

5. The system of claim 4, wherein the SIDR includes information relating to a mobile subscriber, telephone number, location area identity, and numbers required by a network to recognize and authenticate the mobile subscriber.

6. The system of claim 5, wherein the SIDR is a Universal Subscriber Identity Module (“USIM”).

7. The system of claim 5, wherein the SIDR is a Removable User Identity Module (“RUIM”).

8. The system of claim 1, wherein the wireless modem coupled to the digital processing device and capable of communicating with a wireless communications network further includes a receiver and transmitter circuit, wherein the receiver and transmitter circuit is capable of communicating wireless communications over the wireless communications network.

9. The system of claim 8, wherein the wireless communications include transmitting data, voice, and video information.

10. The system of claim 1, wherein the digital processing device is one of a personal digital assistant, a laptop computer, a mobile phone, a personal computer, a server, a workstation, a mini-computer, and a mainframe computer.

11. The system of claim 1,
wherein the first short-range communication circuit is a cable communication circuit for facilitating short-range communication utilizing a cable connection; and
wherein the second short-range communication circuit is a cable communication circuit for facilitating short-range communication utilizing a cable connection.

12. The system of claim 1,
wherein the first short-range communication circuit is a short-range wireless circuit for facilitating short-range wireless communication; and
wherein the second short-range communication circuit is a short-range wireless circuit for facilitating short-range wireless communication.

13. The system of claim 12, wherein the short-range wireless communication is a personal area network.

14. A method for providing a wireless communication, comprising:
activating a short-range communication to identify a device with a subscriber identity data repository (“SIDR”);
issuing a request for establishing a secure short-range communication channel to the device once the device is located;
obtaining subscriber identity data from the SIDR via the secure short-range communication channel; and
requesting a connection to a wireless communications network in accordance with the subscriber identity data.

15. The method of claim 14, wherein activating a short-range communication to identify a device with a SIDR further includes identifying a device with a Universal Subscriber Identity Module (“USIM”).

16. The method of claim 15 wherein activating a short-range communication further includes activating a short-range wireless communication.

17. The method of claim 14, wherein activating a short-range communication to identify a device with a SIDR further includes identifying a device with a Removable User Identity Module (“RUIM”).

18. The method of claim 14, wherein activating a short-range communication to identify a device with a SIDR further includes identifying a handheld device with a subscriber identity module (“SIM”) card.

19. The method of claim 14, further comprising:
initializing the device to include information for identifying the digital processing device; and
initializing the digital processing device to include information for identifying the device.

20. The method of claim 14, further comprising:
receiving authentication request from the wireless communications network;
transmitting the authentication request to the SIDR through the secure short-range wireless communication channel;
receiving an authentication response for the authentication request from the SIDR via the secure short-range communication channel; and
transmitting the authentication response to the wireless communications network.

21. The method of claim 14, wherein activating a short-range communication further includes activating a personal area network.

22. The method of claim 14, wherein the requesting a connection to a wireless communications network further includes activating a wireless modem residing on a removable PCI-Express MiniCard that is logically coupled to the digital processing device.

23. The method of claim 14, wherein activating a short-range communication further includes activating a short-range wireless communication.

24. The method of claim 23, wherein activating a short-range wireless communication to identify a device further includes identifying a cellular phone.

25. The method of claim 24, wherein issuing a request for establishing a first secure short-range wireless communication further includes:
passing a first secret authentication key from the digital processing device to the device; and
passing a second secret authentication key from the device to the digital processing device.

26. The method of claim 25, wherein issuing a request for establishing a first secure short-range wireless communication further includes establishing the secured short-range wireless communication channel if the first secret authentication key and the second secret authentication key are verified.

27. The method of claim 14, wherein obtaining subscriber identity data further includes identifying mobile subscriber, telephone number, and location area identity.

28. The method of claim 14, wherein obtaining Subscriber identity data from the SIDR via the secure short-range communication channel further includes encrypting subscriber identity data before it is transmitted through the secure short-range, communication channel.

29. The method of claim 14, wherein the requesting a connection to a wireless communications network further includes obtaining a token to ensure that only one device can request for wireless communications network at one given time with one set of subscriber identity data.

30. An apparatus for providing a wireless communication, comprising:
means for activating a short-range wireless communication to identify a device with a subscriber identity data repository (“SIDR”);
means for issuing a request for establishing a secure short-range wireless communication channel to the device once the device is located;
means for obtaining subscriber identity data from the SIDR via the secure short-range wireless communication channel; and
means for requesting a connection to a wireless communications network in accordance with the subscriber identity data.

31. The apparatus of claim 30, further comprising:
means for initializing the device to include information for identifying the digital processing device; and
means for initializing the digital processing device to include information for identifying the device.

32. The apparatus of claim 30, further comprising:
means for receiving authentication request from the wireless communications network;
means for transmitting the authentication request to the SIDR through the secure short-range wireless communication channel;
means for receiving an authentication response for the authentication request from the SIDR via the secure short-range wireless communication channel; and
means for transmitting the authentication response to the wireless communications network.

33. The apparatus of claim 30, wherein means for activating a short-range wireless communication further includes means for activating a personal area network.

34. The apparatus of claim 30, wherein the means for requesting a connection to a wireless communications network further includes means for activating a wireless modem residing on a removable PCI-Express MiniCard that is logically coupled to the digital processing device.

35. The apparatus of claim 30, wherein means for activating a short-range wireless communication to identify a device further includes means for identifying a cellular phone.

36. The apparatus of claim 35, wherein means for issuing a request for establishing a first secure short-range wireless communication further includes:
means for passing a first secret authentication key from the digital processing device to the device; and
means for passing a second secret authentication key from the device to the digital processing device.

37. The apparatus of claim 36, wherein means for issuing a request for establishing a first secure short-range wireless communication further includes means for establishing the secured short-range wireless communication channel if the first secret authentication key and the second secret authentication key are verified.

38. The apparatus of claim 30, wherein means for obtaining subscriber identity data further includes means for identifying mobile subscriber, telephone number, and location area identity.

39. The apparatus of claim 30, wherein means for obtaining Subscriber identity data from the SIM via the secure short-range wireless communication channel further includes means for encrypting Subscriber identity data before it is transmitted through the secure short-range wireless communication channel

40. The apparatus of claim 30, wherein the means for requesting a connection to a wireless communications network further includes means for obtaining a token to ensure that only one device can request for wireless communications network at one given time with one set of subscriber identity data.

41. A method for providing a communication, comprising:
activating a short-range communication to identify a device with a subscriber identity data repository (“SIDR”);
issuing a request for establishing a secure communication channel to the device once the device is identified;
obtaining subscriber identity data from the SIDR via the secure communication channel; and
requesting a connection to a wireless communications network in accordance with the subscriber identity data.

42. The method of claim 41,
wherein the activating a short-range communication is further including activating a short-range wireless communication; and
wherein the issuing a request for establishing a secure communication channel further includes establishing a secure short-range wireless communication channel.

43. The method of claim 42, further comprising:
initializing the device to include information for identifying the digital processing device; and
initializing the digital processing device to include information for identifying the device.

44. The method of claim 42, further comprising:
receiving authentication request from the wireless communications network;
transmitting the authentication request to the SIDR through the secure short-range wireless communication channel;
receiving an authentication response for the authentication request from the SIDR via the secure short-range wireless communication channel; and
transmitting the authentication response to the wireless communications network.

45. The method of claim 42, wherein activating a short-range wireless communication further includes activating a personal area network.

46. The method of claim 42, wherein the requesting a connection to a wireless communications network further includes activating a wireless modem residing on a removable PCI-Express MiniCard that is logically coupled to the digital processing device.

47. The method of claim 42,
wherein the activating a short-range communication is further including activating a short-range communication utilizing a cable; and
wherein the issuing a request for establishing a secure communication channel further includes establishing a secure channel for the short-range communication utilizing a cable.

48. The method of claim 42, wherein issuing a request for establishing a secure communication channel further includes:
passing a first secret authentication key from the digital processing device to the device; and
passing a second secret authentication key from the device to the digital processing device.

49. The method of claim 48, wherein passing a second secret authentication key from the cellular phone to the digital processing further includes establishing the secured communication channel if the first secret authentication key and the second secret authentication key are verified.
